(19) United States
(12) Patent Application Publication
(10) Pub. No.: US 2015/0362629 A1
(43) Pub. Date: Dec. 17, 2015

(54) OPTICAL LENS

(71) Applicant: Panasonic Intellectual Property Management Co., Ltd., Osaka (JP)

(72) Inventors: Makoto UMETANI, Osaka (JP); Akira KAWASE, Osaka (JP); Takanori YOGO, Kyoto (JP)

(21) Appl. No.: 14/832,265

(22) Filed: Aug. 21, 2015

Related U.S. Application Data
(63) Continuation of application No. PCT/JP2014/000822, filed on Feb. 18, 2014.

(30) Foreign Application Priority Data
Feb. 25, 2013 (JP) 2013-034832

(51) Int. Cl. G02B 1/04; G02B 1/118; G02B 27/00

(52) U.S. Cl. CPC G02B 1/041; G02B 27/0025; G02B 1/118; Y10S 977/779; B82Y 10/00

(57) ABSTRACT

An optical lens is composed of a nanocomposite material including a resin material and nano-fine particles dispersed in the resin material. The nano-fine particles include indium tin oxide, and Ag or Au. The optical lens has improved performance of compensating chromatic aberration, enables further downsizing of lens barrels, and realizes improved transparency and reduction in scattered light by the nano-fine particles.

### CROSS-REFERENCE TO RELATED APPLICATION

This application is a Continuation of International Application No. PCT/JP2014/000822, filed on Feb. 18, 2014, which in turn claims the benefit of Japanese Application No. 2013-034832, filed on Feb. 25, 2013, the disclosures of which Applications are incorporated by reference herein.

### BACKGROUND

1. Field

The present disclosure relates to optical lenses.

2. Description of the Related Art

Techniques for synthesizing moldable nanocomposite materials having optical constants unlike those of conventional resin materials by dispersing fine particles having specific optical constants in resin materials have been actively developed.

Japanese Laid-Open Patent Publication No. 2001-074901 discloses a nanocomposite material composed of a copolymer of styrene and amorphous polyolefin or methyl methacrylate, and indium tin oxide (hereinafter also referred to as ITO).

Japanese Laid-Open Patent Publication No. 2005-316186 discloses an optical element composed of a mixture obtained by dispersing, in a medium material, inorganic fine particles including at least one of ITO, TiO₂, Nb₂O₅, Cr₂O₃, and BaTiO₃.

Generally in most optical glass, an appropriately linear relationship is established between a partial dispersion ratio (PgF) and an Abbe number (νd) to a d-line. This type of glass is called “normal partial dispersion glass (normal glass)”. On the other hand, a type of glass that deviates from the linear relationship is called “abnormal partial dispersion glass (abnormal glass)”. The magnitude of an anomalous dispersion property (ΔPgF) is expressed by a deviation of the partial dispersion ratio from a standard line obtained by connecting a glass type C7 (to the d-line, refractive index nd: 1.51, νd: 60.5, PgF: 0.54) and a glass type F2 (nd: 1.62, νd: 36.3, PgF: 0.58) which are regarded as standard normal glass. ITO has a very large negative anomalous dispersion property, that is, ΔPgF of −0.16 (derived from values in reference literatures). Therefore, by using an optical lens formed of a nanocomposite material of a resin material and ITO, it is possible to realize a compact lens barrel capable of compensating chromatic aberration as compared with conventional lens barrels.

### SUMMARY

The present disclosure provides an optical lens composed of a nanocomposite material having a very large negative anomalous dispersion property.

The novel concepts disclosed herein were achieved in order to solve the foregoing problems in the related art, and herein is disclosed:

an optical lens comprising a nanocomposite material that includes a resin material, and nano-fine particles dispersed in the resin material, wherein

the nano-fine particles include indium tin oxide, and Ag or Au.

The refractive index of ITO is reduced in an absorption region of Ag or Au, whereby the negative anomalous dispersion property of ITO can be further increased. Therefore, the optical lens according to the present disclosure which is composed of the nanocomposite material in which the nano-fine particles including ITO and Ag or Au are dispersed in the resin material, has improved performance of compensating chromatic aberration. Therefore, the optical lens realizes further downsizing of lens barrels, improved transparency, and reduction in scattered light by the nano-fine particles, as compared with an optical lens composed of a nanocomposite material using the conventional ITO nano-fine particles.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a schematic cross-sectional diagram showing a nanocomposite material, an optical lens composed of the nanocomposite material, and a hybrid lens adopting the optical lens, according to Embodiment 1;

FIG. 2 is a scanning electron micrograph of a surface of an ITO thin film, according to Embodiment 1;

FIG. 3 is a graph showing particle size distribution of ITO fine particles obtained by grinding the ITO thin film, according to Embodiment 1;

FIG. 4 is a graph showing the relationship between the content of nano-fine particles and the anomalous dispersion property (ΔPgF) of the nanocomposite material, according to Embodiment 1;

FIG. 5 is a graph showing the relationship between the content of commercially available ITO nano-fine particles and the anomalous dispersion property (ΔPgF) of the nanocomposite material;

FIG. 6 is a schematic cross-sectional diagram showing a nanocomposite material, an optical lens composed of the nanocomposite material, and a hybrid lens adopting the optical lens, according to Embodiment 2; and

FIG. 7 is a graph showing the relationship between wavelength and reflectance, of Ag and Au.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiment 1

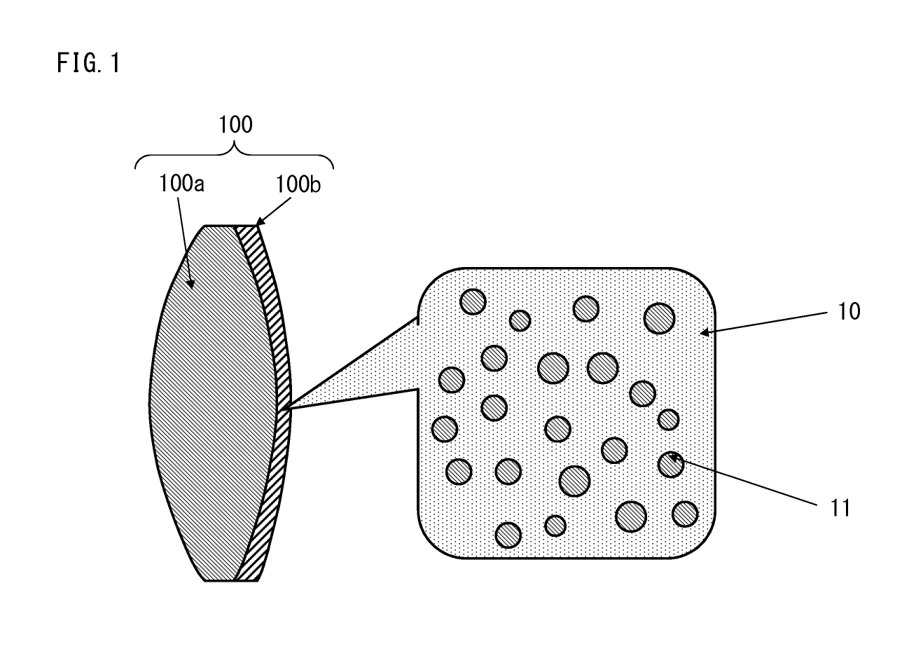

Hereinafter, Embodiment 1 is described with reference to FIGS. 1 to 5.

[1-1. Configuration]

[1-1-1. Configuration of Optical Lens]

FIG. 1 is a schematic cross-sectional diagram showing a nanocomposite material, an optical lens composed of the nanocomposite material, and a hybrid lens adopting the optical lens, according to Embodiment 1. An optical lens 100 is a hybrid lens including a bi-convex glass lens 100a and an optical lens 100b composed of the nanocomposite material according to Embodiment 1, in order to realize compensation of chromatic aberration. In the conventional art, a plurality of glass lenses is needed in order to compensate chromatic aberration. However, the hybrid lens having the above configuration can solely compensate chromatic aberration, and therefore, can realize downsizing.

Although FIG. 1 shows an example of a hybrid lens, it is needless to say that the same effect as the hybrid lens can be achieved even when the optical lens 100b is combined with a separate lens.

The nanocomposite material forming the optical lens 100b shown in FIG. 1 contains a matrix 10 composed of a resin material, and nano-fine particles 11 dispersed in the matrix 10. The nano-fine particles 11 include ITO and Ag or Au.

[1-1-2. Nano-Fine Particles]

The nano-fine particles 11 are uniformly dispersed in the matrix 10 composed of a resin material. The nanocomposite material in which the nano-fine particles 11 each being sufficiently smaller than the wavelength of light are uniformly dispersed can be regarded as a homogeneous medium without variations in the refractive index. In the visible-light region, it is beneficial that the particle diameter of the nano-fine particles 11 is 400 nm or less. When the particle diameter is smaller than one fourth of the wavelength of light, Rayleigh scattering can be suppressed. Therefore, when higher light transmittance is required, it is beneficial that the particle diameter of the nano-fine particles 11 is 100 nm or less in the visible-light region. In order to uniformly disperse such very small nano-fine particles, it is beneficial that the surface of each nano-fine particle is subjected to surface modification or coated with a dispersant to suppress aggregation of the nano-fine particles.

It is beneficial that the nano-fine particles 11 including ITO and Ag or Au, which are used in the nanocomposite material of Embodiment 1, are hybrid nano-fine particles in which Ag or Au is added to ITO, or hybrid nano-fine particles in which ITO is added to Ag or Au. The method for forming such hybrid nano-fine particles is not particularly limited. A liquid phase method such as a coprecipitation method, a sol-gel method, or metal complex decomposition or a vapor phase method such as vapor deposition, CVD, sputtering, or ion plating can be adopted. Alternatively, a method of grinding a composite compound in which Ag or Au is added to ITO into fine particles by using a ball mill or a bead mill can be adopted.

In the present disclosure, an example is shown in which a thin film formed by sputtering is ground into hybrid nano-fine particles.

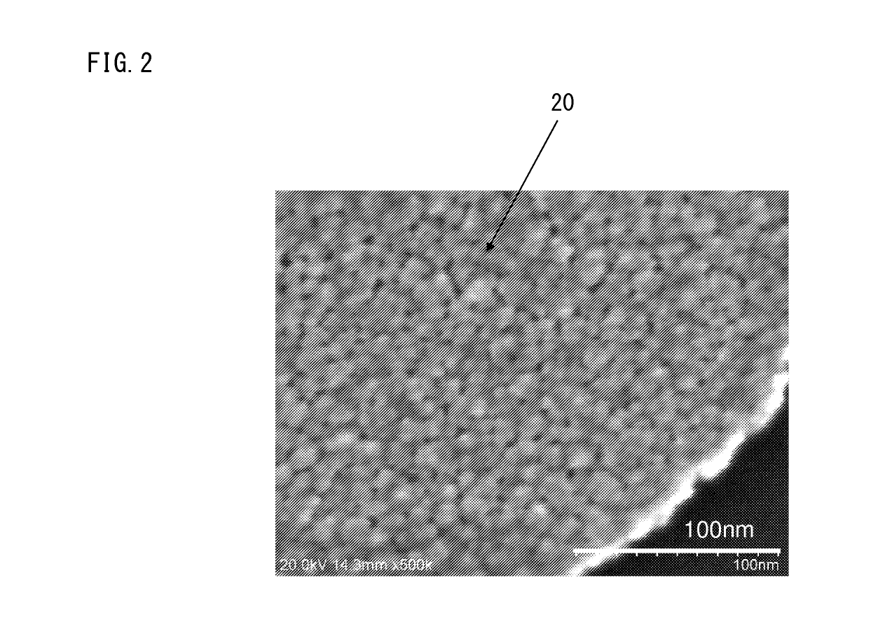

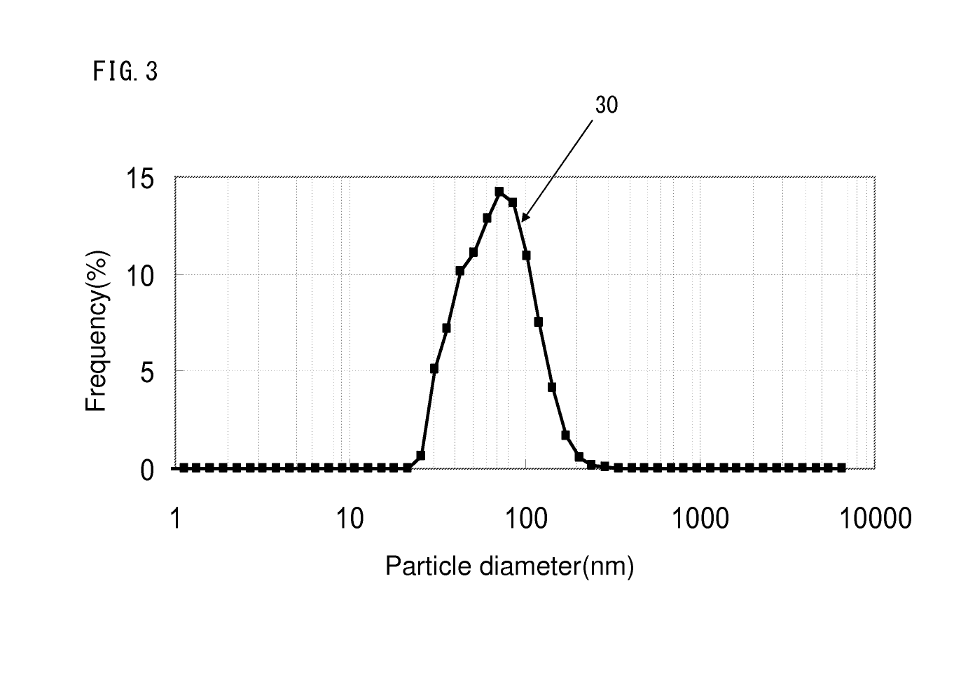

FIG. 2 shows a scanning electron micrograph of a surface of an ITO thin film formed by sputtering. It is apparent from FIG. 2 that the ITO thin film is an aggregation of ITO nano-fine particles 20 having the particle diameter ranging from several nm to several tens nm. By grinding the ITO thin film with a ball mill, powder of ITO nano-fine particles shown by a particle size distribution graph 30 in FIG. 3 can be obtained.

The hybrid nano-fine particles in which Ag or Au is added to ITO can be easily formed by sputtering, specifically, by placing a chip target of Ag or Au on an ITO target, and sputtering the targets at the same time, for example.

[1-1-3. Matrix Composed of Resin Material]

As the matrix 10 composed of a resin material, a resin having a high light transmittance selected from resins such as thermoplastic resins, thermosetting resins, and energy ray-curable resins can be used. For example, acrylic acid resins, methacrylic acid resins, epoxy resins, polyester resins, polystyrene resins, polyolefin resins, polyamide resins, polyimide resins, polyvinyl alcohol, butyral resins, vinyl acetate resins, alicyclic polyolefin resins, and the like can be used. Besides, engineering plastics such as polycarbonate, liquid crystal polymers, polyphenylene ether, polysulfone, polyether sulfone, polyarylate, and amorphous polyolefin can also be used. Further, silicone resins and the like can also be used. Mixtures and copolymers of these resins may also be used. Resins obtained by modifying these resins may also be used. The matrix 10 composed of a resin material is not particularly limited, and the present disclosure is not intended to restrict the subject matter of the scope of claim for patent.

[1-2. Function]

[1-2-1. Optical Property of Nano-Fine Particles]

In the present disclosure, the optical properties of the hybrid nano-fine particles in which Ag is added to ITO are evaluated by measuring, in the state of the thin film formed by sputtering, the refractive index thereof by DPSD (Differential Power Spectral Density) using a non-contact optical thin-film measuring system (FilmTek 4000, manufactured by Scientific Computing International).

Based on the measurement result of the refractive index of the hybrid nano-fine particles and refractive index data of an ITO thin film as a comparative example to which Ag is not added (data from RefractiveIndex.INFO-Refractive index database), ΔPgF is calculated for the hybrid nano-fine particles in which Ag is added to ITO and for the ITO thin film to which Ag is not added, by using a refractive index ng to the g-line (wavelength: 435.84 nm), a refractive index nF to the F-line (wavelength: 486.13 nm), a refractive index nd to the d-line (wavelength: 587.56 mu), and a refractive index nC to the C-line (wavelength: 656.27 nm), and a straight line passing through the coordinates of glass types C7 (nd: 1.51, νd: 60.5, PgF: 0.54) and F2 (nd: 1.62, νd: 36.3, PgF: 0.58) as a standard line of normal partial dispersion glass based on the standards of HOYA Corporation. The result is shown in Table 1.

TABLE 1

| | | Optical property | |
|---|---|---|---|
| Kinds of | Wavelength | Hybrid | |
| refractive index | (nm) | nano-fine particles | ITO |
| ng | 435.84 | 1.98199 | 2.05686 |
| nF | 486.13 | 1.93154 | 1.98868 |
| nd | 587.56 | 1.81068 | 1.89014 |
| nC | 656.27 | 1.71390 | 1.84416 |

| | | |
|---|---|---|
| ΔPgF | −0.40981 | −0.16546 |

As shown in Table 1, it is confirmed that the negative anomalous dispersion property of ITO can be further increased by reducing the refractive index of ITO in the absorption region of Ag (the short wavelength region near 400 nm).

Au also has large absorption in the short wavelength region near 400 nm, and therefore, has the effect of reducing the refractive index of ITO like Ag. Thus the negative anomalous dispersion property of ITO can be further increased.

The composition ratio of the hybrid nano-fine particles in which Ag is added to ITO is In:Sn:Ag=89.95:8.15:1.89. Since transmitted light is used for measurement of the refractive index, the fact that measurement of the refractive index is possible means that the hybrid nano-fine particles have light transmittance. When the content of Ag in the hybrid nano-fine particles exceeds 10%, the light transmittance is reduced to an extent that the refractive index cannot be measured. Therefore, practically, the content of Ag is beneficially 10% or less, and more beneficially, 1% to 5%.

Likewise, regarding Au, when the content of Au in the hybrid nano-fine particles in which Au is added to ITO exceeds 10%, the light transmittance is reduced to an extent that the refractive index cannot be measured. Therefore, practically, the content of Au is beneficially 10% or less, and more beneficially, 1% to 5%.

[1-2-2. Optical Property of Nanocomposite Material]

As the matrix 10 composed of a resin material, a cured polymer is obtained by adding a commercially available polymerization initiator to a commercially available polyolefin ultraviolet-curable resin, and irradiating the resin with an ultraviolet ray emitted from an UV lamp to polymerize and cure the resin. The optical properties (ng, nF, nd, nC, and ΔPgf) of the cured polymer are shown in Table 2.

TABLE 2
Optical property of cured polymer

| ng | nF | nd | nC | ΔPgf |
|---|---|---|---|---|
| 1.52141 | 1.51631 | 1.50989 | 1.50717 | 0.01020 |

An average refractive index n_{X} of the nanocomposite material at a wavelength λ can be roughly calculated as shown in the following formula (1), according to the Lorentz theory, using a refractive index n₁ of the nano-fine particles 11, a refractive index n₀ of the matrix 10 composed of a resin material, and a volume ratio k of the nano-fine particles 11 to the entire nanocomposite material, at the wavelength λ.

(n_{X}²−1)/(n_{X}²+2)=k×(n₁²−1)/(n₁²+2)+(1−k)×(n₀²−1)/(n₀²+2) (1)

Usually, a dispersant or the like is included in the nanocomposite material besides the matrix 10 composed of a resin material and the nano-fine particles 11. Therefore, the optical properties of the actual nanocomposite material are not exactly the same as the values roughly calculated by the above formula (1). However, the actual values do not very much deviate from the calculated values, and the magnitude relationship can be approximately evaluated according to formula (1).

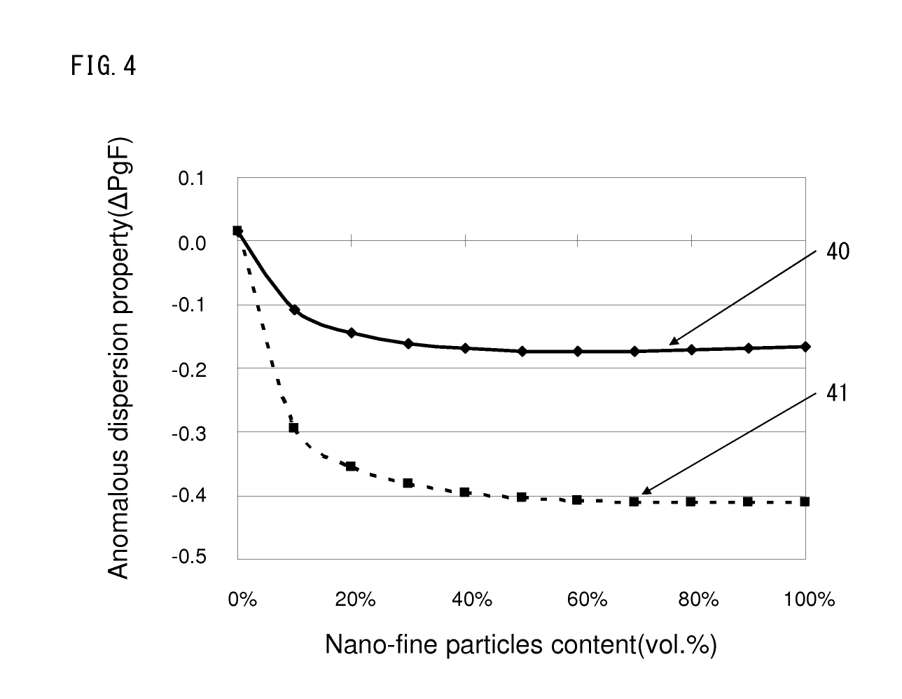

Based on the optical properties of the hybrid nano-fine particles in which Ag is added to ITO and the ITO nano-fine particles in which Ag is not added to ITO, and the refractive index data of the commercially available polyolefin ultraviolet-curable resin, change in ΔPgF of the nanocomposite material is examined, with the content of each of the hybrid nano-fine particles and the ITO nano-fine particles being gradually increased from 0 vol. % to 100 vol. % by 10 vol. %. The result is shown in the graph of FIG. 4.

From a graph 40 of the nanocomposite material containing the ITO nano-fine particles and a graph 41 of the nanocomposite material containing the hybrid nano-fine particles in which Ag is added to ITO, it is found that, in both cases, the negative anomalous dispersion property (ΔPgF) increases with increase in the content of the nano-fine particles. In both cases, when the content of the nano-fine particles is increased to about 10 vol. %, the ΔPgF of the nanocomposite material rapidly approaches the ΔPgF (value on Table 1: −0.16546) of the nano-fine particles, and thereafter, gently increases. This means that the ΔPgF of the nanocomposite material greatly depends on the ΔPgF of the nano-fine particles.

As is evident from the graph 41 of the present disclosure, the ΔPgF of the nanocomposite material containing the hybrid nano-fine particles in which Ag is added to ITO, when the content of the hybrid nano-fine particles is about 2 to 3 vol. %, becomes substantially equal to the ΔPgF of the nanocomposite material containing the ITO nano-fine particles in which Ag is not added, and the nanocomposite material in which the hybrid nano-fine particles are dispersed at the content of 10 vol. % has the negative anomalous dispersion property about three times of the negative anomalous dispersion property of the nanocomposite material using the ITO nano-fine particles in which Ag is not added.

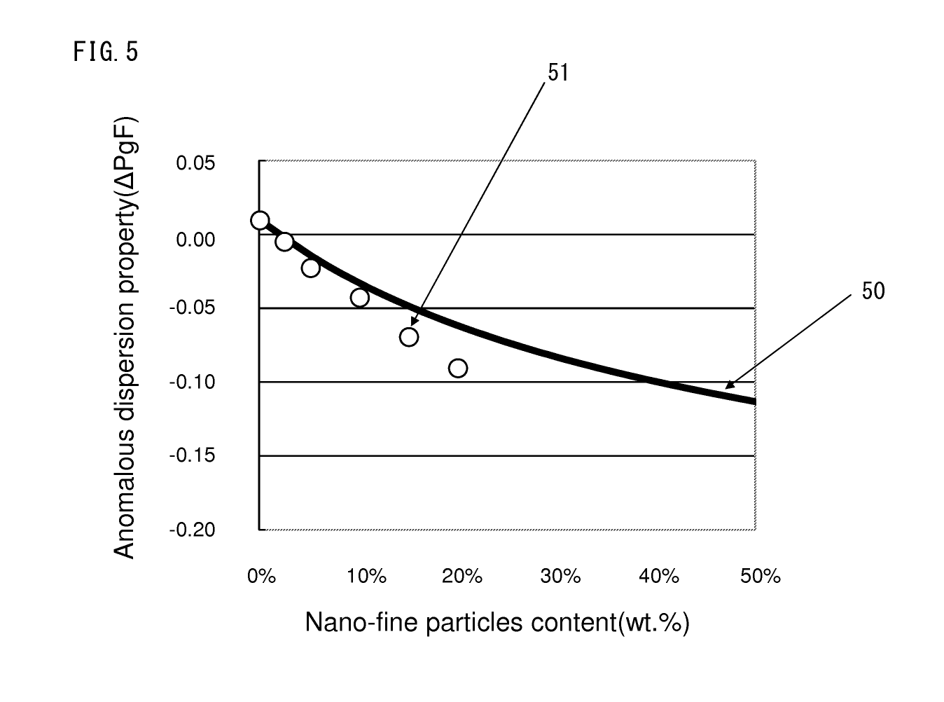

FIG. 5 is a graph showing the relationship between the content of the commercially available ITO nano-fine particles and the anomalous dispersion property (ΔPgF) of the nanocomposite material. FIG. 5 shows: plots 51 of ΔPgF, for the respective contents (wt. %) of the ITO nano-fine particles, calculated based on actual measurement data of a nanocomposite material obtained by dispersing ITO nano-fine particles in a commercially available polyolefin resin, and curing the resin; and a graph 50 based on the values roughly calculated in the above formula (1). It is found that, due to influence of the dispersant or the like, the anomalous dispersion property indicated by the plots 51 based on the actual measurement data is slightly larger than that indicated by the graph 50 using the values roughly calculated in the formula (1), but the plots 51 are almost on the graph 50. Therefore, if the refractive index and the content of the nano-fine particles are known, the anomalous dispersion property (ΔPgF) of the nanocomposite material can be calculated with high accuracy according to the formula (1).

That is, the hybrid nano-fine particles in which Ag or Au is added to ITO according to the present disclosure has the very large negative anomalous dispersion property (ΔPgF) as compared with that of the ITO nano-fine particles. Thus, by using the hybrid nano-fine particles, a nanocomposite material having the large negative anomalous dispersion property (ΔPgF) can be provided.

[1-3. Effect]

As described above, in Embodiment 1, the hybrid nano-fine particles having the very large negative anomalous dispersion property (ΔPgF) as compared with that of the ITO nano-fine particles can be provided. An optical lens composed of the nanocomposite material using the hybrid nano-fine particles has improved performance of compensating chromatic aberration. Therefore, as compared with an optical lens composed of a material using the conventional ITO nano-fine particles, the optical lens of Embodiment 1 realizes further downsizing of lens barrels, improved transparency, and reduction in scattered light by the nano-fine particles, and therefore, is very effective for improvement of optical performance of lens barrels.

For example, the effect of reducing scattered light by the nano-fine particles is described with reference to FIG. 4. As shown by the graph 40, in the case of the nanocomposite material containing the conventional ITO nano-fine particles, about 10 vol. % of the ITO nano-fine particles need to be dispersed in order to achieve ΔPgF of −0.1. In contrast, as shown by the graph 41, in the case of the nanocomposite material containing the hybrid nano-fine particles in which Ag is added to ITO according to Embodiment 1, only about 3 vol. % of the hybrid nano-fine particles need to be dispersed in order to achieve ΔPgF of −0.1, and this content is about ⅓ of the content of the nanocomposite material using the conventional ITO nano-fine particles. That is, the nanocomposite material of the present disclosure provides the effect that the loss of light quantity due to scattering is reduced to about ⅓ of that of the conventional nanocomposite material.

In Embodiment 1, the effect of the hybrid nano-fine particles in which Ag is added to ITO has been described. However, it is needless to say that the same effect as described above can be achieved by using nano-fine particles having a very large negative anomalous dispersion property (ΔPgF) as compared with that of the ITO nano-fine particles.

In the present disclosure, using Ag or Au having absorption in the short wavelength region near 400 nm, nano-fine particles including ITO and Ag or Au, such as hybrid nano-fine particles in which Ag or Au is added to ITO or hybrid nano-fine particles in which ITO is added to Ag or Au, are formed, and the nano-fine particles are dispersed in a resin material to provide a nanocomposite material. Therefore, it is possible to provide an optical lens which realizes further downsizing of lens barrels, improved transparency, and reduction in scattered light by the nano-fine particles, and is significantly effective for improvement of optical performance of lens barrels, as compared with a material using the conventional ITO nano-fine particles.

### Embodiment 2

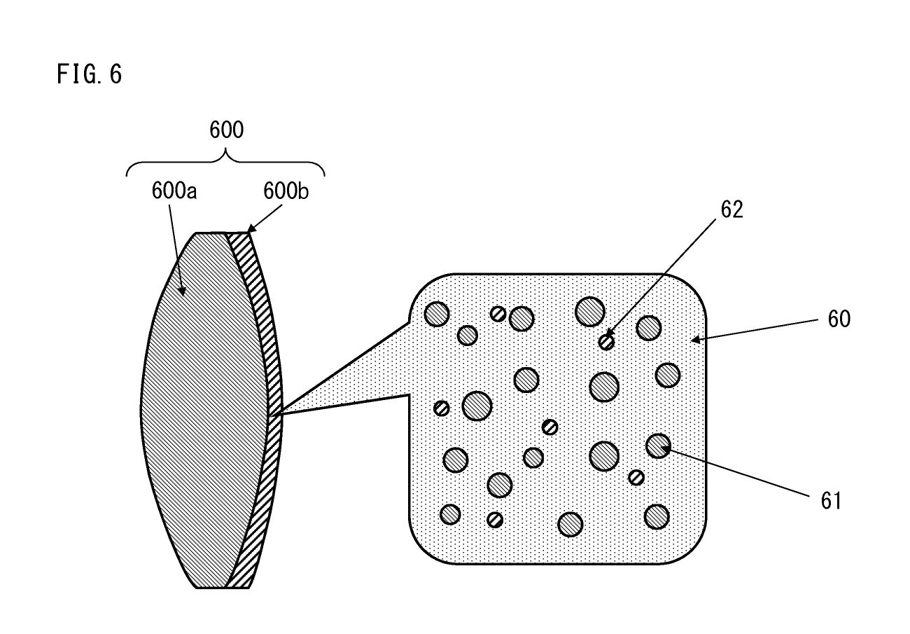

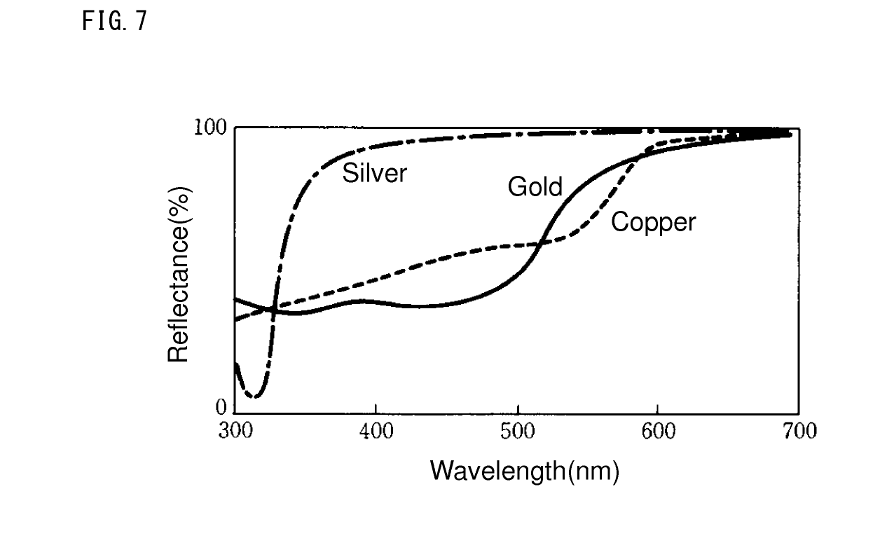

Hereinafter, Embodiment 2 is described with reference to FIGS. 6 to 7.

[2-1. Configuration]

[2-1-1. Configuration of Optical Lens]

FIG. 6 is a schematic cross-sectional diagram showing a nanocomposite material, an optical lens composed of the nanocomposite material, and a hybrid lens adopting the optical lens. An optical lens 600 is a hybrid lens including a bi-convex glass lens 600a and an optical lens 600b composed of the nanocomposite material according to Embodiment 2, in order to realize compensate chromatic aberration. In the conventional art, a plurality of glass lenses is needed in order to compensate chromatic aberration. However, the hybrid lens having the above configuration can solely compensate chromatic aberration, and therefore, can realize downsizing.

Although FIG. 6 shows an example of a hybrid lens, it is needless to say that the same effect as the hybrid lens can be achieved even when the optical lens 600b is combined with a separate lens.

The nanocomposite material forming the optical lens 600b shown in FIG. 6 contains a matrix 60 composed of a resin material, and ITO nano-fine particles 61 and Ag nano-fine particles or Au nano-fine particles 62 dispersed in the matrix 60.

[2-1-2. Nano-Fine Particles]

The ITO nano-fine particles 61 and the Ag nano-fine particles or Au nano-fine particles 62 are uniformly dispersed in the matrix 60 composed of a resin material. The nanocomposite material in which the nano-fine particles 61 and 62 each being sufficiently smaller than the wavelength of light are uniformly dispersed can be regarded as a homogeneous medium without variations in the refractive index. In the visible-light region, it is beneficial that the particle diameter of each of the nano-fine particles 61 and 62 is 400 nm or less. When the particle diameter is smaller than one fourth of the wavelength of light, Rayleigh scattering can be suppressed. Therefore, when higher light transmittance is required, it is beneficial that the particle diameter of each of the nano-fine particles 61 and 62 is 100 nm or less in the visible-light region. In order to uniformly disperse such very small nano-fine particles, it is beneficial that the surface of each nano-fine particle is subjected to surface modification or coated with a dispersant to suppress aggregation of the nano-fine particles.

The method for forming the multiple kinds of nano-fine particles including the ITO nano-fine particles 61 and the Ag nano-fine particles or Au nano-fine particles 62, which are used in the nanocomposite material according to Embodiment 2, is not particularly limited. A liquid phase method such as a coprecipitation method, a sol-gel method, or metal complex decomposition or a vapor phase method such as vapor deposition, CVD, sputtering, or ion plating can be adopted.

[2-1-3. Matrix Composed of Resin Material]

As the matrix 60 composed of a resin material, a resin having a high light transmittance selected from resins such as thermoplastic resins, thermosetting resins, and energy ray-curable resins can be used. For example, acrylic acid resins, methacrylic acid resins, epoxy resins, polyester resins, polystyrene resins, polyolefin resins, polyamide resins, polyimide resins, polyvinyl alcohol, butyral resins, vinyl acetate resins, alicyclic polyolefin resins, and the like can be used. Besides, engineering plastics such as polycarbonate, liquid crystal polymers, polyphenylene ether, polysulfone, polyether sulfone, polyarylate, and amorphous polyolefin can also be used. Further, silicone resins and the like can also be used. Mixtures and copolymers of these resins may also be used. Resins obtained by modifying these resins may also be used. The matrix 60 composed of a resin material is not particularly limited, and the present disclosure is not intended to restrict the subject matter of the scope of claim for patent.

[2-2. Function]

[2-2-1. Optical Property of Ag Nano-Fine Particles or Au Nano-Fine Particles]

FIG. 7 is a graph showing the relationship between wavelength and reflectance, of Ag and Au. Ag and Au have absorption in the short wavelength region near 400 nm, as shown in FIG. 3, which is the same as the above FIG. 7, of Physical Origins of Colors of Metals: Seminar of Japan Institute of Metals and Materials “Coexistence of Metal Materials and Human Beings—Science and Technology of Colors and Textures of Metals” (written by Katsuaki Sato, 2007.4.17, p. 2), and as shown in FIG. 2 of Investigation of Factors for High Efficiency of Semiconductor Solar Cells by Application of Metal Nano-Particles Dispersed Film, SCEJ 75th Annual Meeting (written by Yuuki Tanaka, Hironori Hachimura, and Manabu Ihara, Kagoshima, 2010, p. 607). A nanocomposite material which is obtained by mixing Ag nano-fine particles or Au nano-fine particles with ITO nano-fine particles and then dispersing the mixture in a resin material, has the effect of reducing the refractive index of ITO in the short wavelength region, like the nanocomposite material according to Embodiment 1. Therefore, it is needless to say that the optical lens 600b shown in FIG. 6, which is composed of the nanocomposite material obtained by dispersing, in the resin material 60, multiple kinds of nano-fine particles including the Ag nano-fine particles or Au nano-fine particles 62 and the ITO nano-fine particles 61, has a large negative anomalous dispersion property (ΔPgF).

The ratio of the ITO nano-fine particles to the Ag nano-fine particles or Au nano-fine particles has an optimum value depending on the situation. However, considering the light transmittance of the intended optical lens, the content of the Ag nano-fine particles or Au nano-fine particles in the multiple kinds of nano-fine particles including the ITO nano-fine particles and the Ag nano-fine particles or Au nano-fine particles is beneficially 10% or less, and more beneficially, 1% to 5%. However, in accordance with the kind of the resin material and/or the composition of ITO, any amount of Ag nano-fine particles or Au nano-fine particles, by which only the refractive index of ITO in the short wavelength region can be significantly reduced, may be used.

[2-3. Effect]

As described above, in Embodiment 2, it is possible to provide the multiple kinds of nano-fine particles including the ITO nano-fine particles and the Ag nano-fine particles or Au nano-fine particles, which have a very large negative anomalous dispersion property (ΔPgF) as compared with that of the ITO nano-fine particles. An optical lens composed of the nanocomposite material using the multiple kinds of nano-fine particles has improved performance of compensating chromatic aberration. Therefore, as compared with an optical lens composed of a material using the conventional ITO nano-fine particles, the optical lens of Embodiment 2 realizes further downsizing of lens barrels, improved transparency, and reduction in scattered light by the nano-fine particles, and therefore, is very effective for improvement of optical performance of lens barrels.

The present disclosure is applicable to imaging devices such as digital still cameras. Specifically, the present disclosure is applicable to video movie cameras, camera-equipped cellular phones, camera-equipped smartphones, surveillance cameras, and the like.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. An optical lens comprising a nanocomposite material that includes a resin material, and nano-fine particles dispersed in the resin material, wherein
the nano-fine particles include indium tin oxide, and Ag or Au.

2. The optical lens as claimed in claim 1, wherein the nano-fine particles are hybrid nano-fine particles in which Ag or Au is added to indium tin oxide.

3. The optical lens as claimed in claim 1, wherein the nano-fine particles are hybrid nano-fine particles in which indium tin oxide is added to Ag or Au.

4. The optical lens as claimed in claim 1, wherein the nano-fine particles are multiple kinds of nano-fine particles including indium tin oxide nano-fine particles, and Ag nano-fine particles or Au nano-fine particles.

5. The optical lens as claimed in claim 1, wherein a particle diameter of the nano-fine particles dispersed in the resin material is 100 nm or less.
